(19) United States
(12) Patent Application Publication
(10) Pub. No.: US 2014/0163868 A1
(43) Pub. Date: Jun. 12, 2014

(54) ELECTRONIC DEVICE AND INDOOR NAVIGATION METHOD

(71) Applicants: Chiun Mai Communication Systems, Inc., New Taipei (TW); SHENZHEN FUTAIHONG PRECISION INDUSTRY CO., LTD., Shenzhen (CN)

(72) Inventor: FEI HUANG, Shenzhen (CN)

(73) Assignees: CHIUN MAI COMMUNICATION SYSTEMS, INC., New Taipei (TW); SHENZHEN FUTAIHONG PRECISION INDUSTRY CO., LTD., Shenzhen (CN)

(21) Appl. No.: 14/064,197

(22) Filed: Oct. 28, 2013

(30) Foreign Application Priority Data
Dec. 10, 2012 (CN) 2012105256706

(51) Int. Cl. G01C 21/20

(52) U.S. Cl. CPC G01C 21/206
USPC 701/425

(57) ABSTRACT

An indoor navigation method using an electronic device includes acquiring an indoor map of a specified building. The method acquires position information by reading a two dimensional (2D) bar code in the specified building using an image capturing device of the electronic device. A target location in the specified building is determined in response to receiving user input, and a predetermined direction is guided by a direction guiding device. The method marks a navigation route on the indoor map according to the acquired position information, the predetermined direction and the target location, and outputs a prompt of the marked navigation route.

### BACKGROUND

1. Technical Field

Embodiments of the present disclosure relate to navigation technology, and particularly to an electronic device and an indoor navigation method using the electronic device.

2. Description of Related Art

An electronic device having a global positioning system (GPS) can be used to position and navigate. However, the GPS cannot provide location information of the mobile terminal at regions that GPS satellite signals are weak (e.g., indoor environments, tunnels, underground parking lots, downtown areas). In addition, most current mobile positioning technologies in cellular Networks (e.g., the Global System for Mobile Communications, or the 3rd-generation) also cannot provide accurate position information of the electronic device, especially when the electronic device is indoors. Therefore, an improved indoor navigation method using the electronic device is desired.

### BRIEF DESCRIPTION OF THE DRAWINGS

FIG. 1 is a block diagram of one embodiment of an electronic device including a navigation system.

FIG. 2 is a schematic diagram of a navigation route provided by the navigation system.

FIG. 3 is a flowchart of one embodiment of an indoor navigation method using the navigation system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

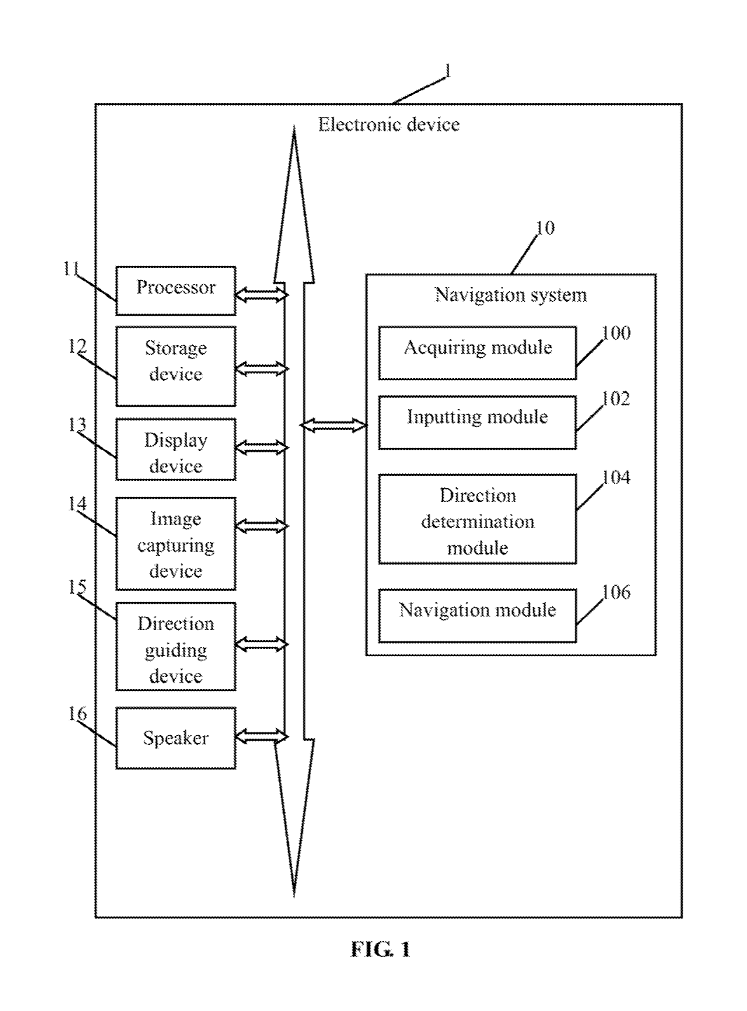

FIG. 1 is a block diagram of one embodiment of an electronic device 1 including a navigation system 10. The electronic device 1 can be a communication device (e.g., a mobile phone), a tablet computer, a personal digital assistant, a notebook computer, or any other computing device. The electronic device 1 includes at least one processor 11, a storage device 12, a display device 13, an image capturing device 14, a direction guiding device 15, and a speaker 16. In other embodiments, the electronic device 1 can include more or fewer components than illustrated, or have a different configuration of the various components.

The at least one processor 11 is used to execute the navigation system 10 and other applications, such as an operating system, installed in the electronic device 1. The storage devices 12 store one or more programs, such as the operating system and applications of the electronic device 1. The storage device 12 can be a storage card, such as a memory stick, a smart media card, a compact flash card, a secure digital card, or any other type of memory storage device.

The display device 13 displays visible data, such as videos, images, or the like. The image capturing device 14 is used to capture or scan an image of a target object. For example, the image capturing device 14 is a camera, or a scanning device. In some embodiments, the image capturing device 14 can scan a two dimensional (2D) bar code to read information (e.g., position information) recorded in the 2D bar code.

The direction guiding device 15 guides a predetermined direction, such as north, or south. The direction guiding device 15 may be a compass. The speaker 16 outputs audio signals, such as music, for example.

The navigation system 10 acquires position information of a current indoor location of the electronic device 1 by scanning the 2D bar code using the image capturing device 14, generates a navigation route according to a target location inputted by a user of the electronic device 1, and outputs a prompt of the navigation route.

The navigation system 10 may include computerized instructions in the form of one or more programs that are executed by the at least one processor 11 and stored in one or more of the storage devices 12. In one embodiment, the navigation system 10 includes one or more modules, for example, an acquiring module 100, an inputting module 102, a direction determination module 104, and a navigation module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

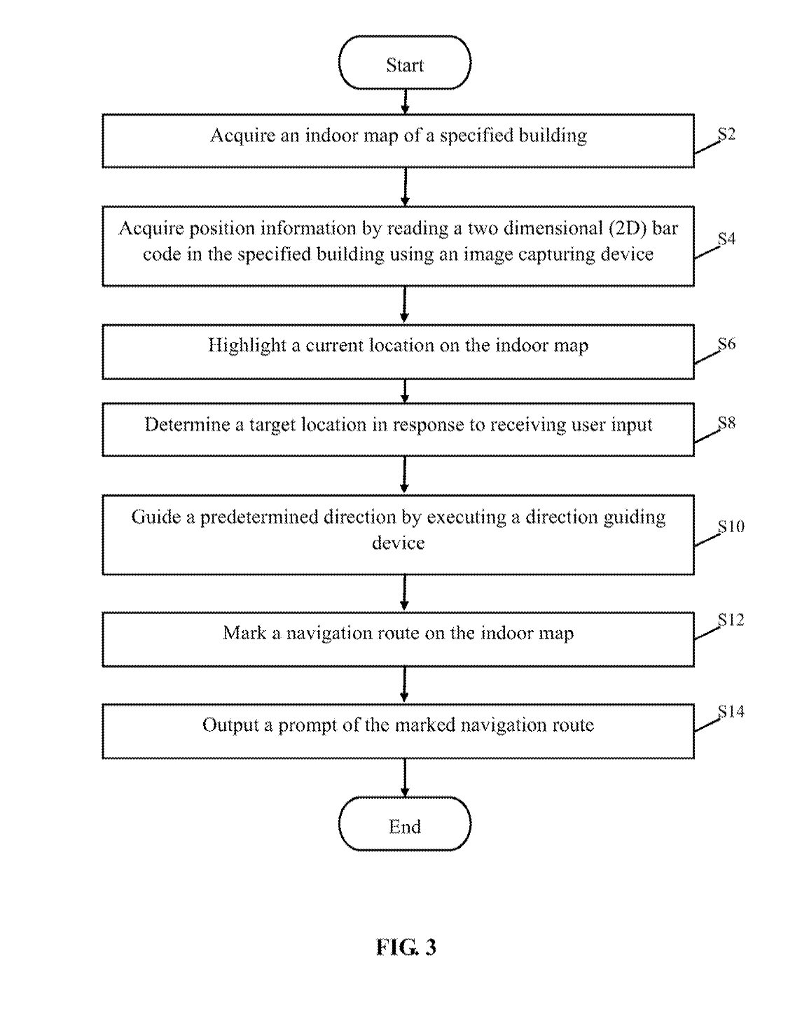

FIG. 3 is a flowchart of one embodiment of an indoor navigation method using the navigation system 10. Depending on the embodiment, additional steps may be added, others removed, and the ordering of the steps may be changed.

In step S2, the acquiring module 100 acquires an indoor map of a specified building. The specified building may be a supermarket, a mall, or an office. When the specified building has multiple floors, an indoor map of each floor of the specified building can be acquired. In some embodiments, the acquiring module 100 acquires the indoor map by downloading from a website provided by a service provider through a network (e.g., the Internet, an intranet, the WIFI), or by scanning a specified 2D bar code which records the indoor map of the specified building.

A plurality of 2D bar codes are applied in these embodiments to record different indoor maps, position information, and/or a map of the 2D bar codes. For example, in the supermarket, a 2D bar code that records an indoor map of the supermarket is placed closer to an entrance of the supermarket, and other 2D bar codes are placed on distributed racks for goods, to record position information of the racks respectively. Furthermore, a position of each of the 2D bar codes can be marked on the indoor maps. The position information may include, but is not limited to longitude, latitude, and altitude of a location of each of the 2D bar codes.

In step S4, the acquiring module 100 acquires position information by reading a 2D bar code at a current location of the electronic device 1 in the specified building, using the image capturing device 14. In some embodiments, the position information recorded in the 2D bar code is used to represent the current location of the 2D bar code, when the image capturing device 14 is used to capture or scan the 2D bar code, the position information of the 2D bar code is regarded as position information of the electronic device 1 at the current location.

Furthermore, as mentioned above, the 2D bar code may record both of the position information and the indoor map, when the image capturing device 14 is used to capture or scan the 2D bar code, the indoor map and the position information of the current location can be acquired by the acquiring module 100 at the same time.

In step S6, the navigation module 106 highlights the current location on the indoor map. For example, the navigation module 106 highlights the current location by drawing an indication symbol (e.g., a circle, a triangle, or an arrow) at the current location on the indoor map.

In step S8, the inputting module 102 determines a target location in the specified building in response to receiving user input. In some embodiments, the inputting module 102 provides an inputting interface or an inputting column for the user of the electronic device 1 to input information of the target location, such as a name or coordinates of the target location. The name of the target location may be an “entrance”, an “exit”, “cash register(s).”

In other embodiments, the inputting module 102 determines the target location by recognizing a touched position on the indoor map according to a manual touch operation of the user. For example, a finger or a stylus touches the touched location on the indoor map, and the inputting module 102 determines the target location by recording coordinates of the touched location.

In step S10, the direction determination module 104 executes the direction guiding device 15 to guide a predetermined direction. As mentioned above, the direction guiding device 15 is a compass, and the predetermined direction is south or north.

In step S12, the navigation module 106 marks a navigation route on the indoor map according to the position information of the current location of the electronic device 1, the predetermined direction and the target location.

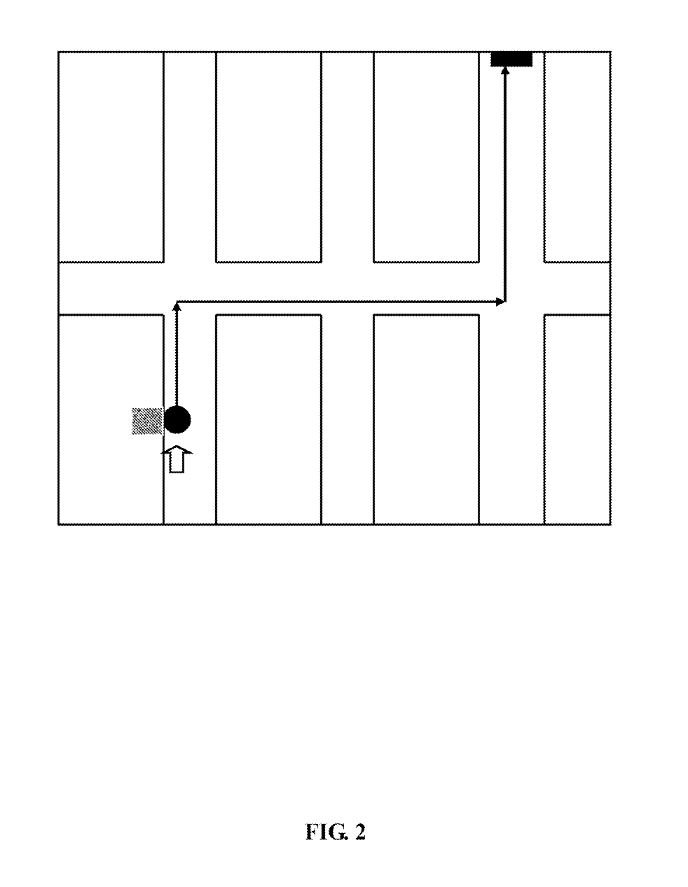

As shown in FIG. 2, a circle is used to represent the user, and the user is at a location of the 2D bar code at the bottom left corner of the indoor map. The current location of the user is represented with a big arrow, and a rectangle represents the target location. The navigation module 106 draws the navigation route from the current location of the user to the target location using beelines and small arrows. The small arrows indicate a moving direction of the navigation route.

In step S14, the navigation module 106 outputs a prompt of the marked navigation route by displaying the marked navigation route on the display device 13, or by outputting audio signals of the marked navigation route using the speaker 16.

It should be emphasized that the above-described embodiments of the present disclosure, particularly, any embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented indoor navigation method using an electronic device, the electronic device comprising an image capturing device and a direction guiding device, the method comprising:
acquiring an indoor map of a specified building;
acquiring position information by reading a two dimensional (2D) bar code in the specified building using the image capturing device;
determining a target location in the specified building in response to receiving user input;
guiding a predetermined direction using the direction guiding device;
marking a navigation route on the indoor map according to the acquired position information, the predetermined direction and the target location; and
outputting a prompt of the marked navigation route.

2. The method according to claim 1, further comprising:
highlighting the current location on the indoor map.

3. The method according to claim 2, wherein the current location is highlighted by drawing an indication symbol at the current location on the indoor map.

4. The method according to claim 1, wherein the acquired position information comprises longitude, latitude, and altitude of the current location.

5. The method according to claim 1, wherein the prompt of the marked navigation route is outputted by displaying the marked navigation route on a display device of the electronic device, or by outputting audio signals of the marked navigation route using a speaker of the electronic device.

6. The method according to claim 1, wherein the direction guiding device is a compass.

7. An electronic device comprising:
an image capturing device and a direction guiding device;
at least one processor; and
a plurality of storage devices storing files and a plurality of instructions, which when executed by the processor, causes the at least one processor to:
acquire an indoor map of a specified building;
acquire position information by reading a two dimensional (2D) bar code in the specified building using the image capturing device;
determine a target location in the specified building in response to receiving user input;
guide a predetermined direction using the direction guiding device;
mark a navigation route on the indoor map according to the acquired position information, the predetermined direction and the target location; and output a prompt of the marked navigation route.

8. The electronic device according to claim 7, wherein the at least one processor further highlights the current location on the indoor map.

9. The electronic device according to claim 8, wherein the current location is highlighted by drawing an indication symbol at the current location on the indoor map.

10. The electronic device according to claim 7, wherein the acquired position information comprises longitude, latitude, and altitude of the current location.

11. The electronic device according to claim 7, wherein the prompt of the marked navigation route is outputted by displaying the marked navigation route on a display device of the electronic device, or by outputting audio signals of the marked navigation route using a speaker of the electronic device.

12. The electronic device according to claim 7, wherein the direction guiding device is a compass.

13. A non-transitory storage medium having stored thereon instructions that, when executed by a processor of an electronic device, causes the electronic device to perform an indoor navigation method, the electronic device comprising an image capturing device and a direction guiding device, the method comprising:
acquiring an indoor map of a specified building;
acquiring position information by reading a two dimensional (2D) bar code in the specified building using the image capturing device;
determining a target location in the specified building in response to receiving user input;
guiding a predetermined direction using the direction guiding device;
marking a navigation route on the indoor map according to the acquired position information, the predetermined direction and the target location; and
outputting a prompt of the marked navigation route.

14. The non-transitory storage medium according to claim 13, wherein the method further comprises:
highlighting the current location on the indoor map.

15. The non-transitory storage medium according to claim 14, wherein the current location is highlighted by drawing an indication symbol at the current location on the indoor map.

16. The non-transitory storage medium according to claim 13, wherein the acquired position information comprises longitude, latitude, and altitude of the current location.

17. The non-transitory storage medium according to claim 13, wherein the prompt of the marked navigation route is outputted by displaying the marked navigation route on a display device of the electronic device, or by outputting audio signals of the marked navigation route using a speaker of the electronic device.

18. The non-transitory storage medium according to claim 13, wherein the direction guiding device is a compass.
